(19) United States
(12) Patent Application Publication
(10) Pub. No.: US 2007/0180385 A1
(43) Pub. Date: Aug. 2, 2007

(54) Apparatus for visual navigation of large, complex out-of-band and in-band network management and access entities

(76) Inventors: Siva Somasundaram, Dayton, NJ (US); Yee Liaw, Warren, NJ (US)

Correspondence Address: GIBBONS P.C., ONE GATEWAY CENTER, NEWARK, NJ, 07102, US

(21) Appl. No.: 11/701,075

(22) Filed: Feb. 1, 2007

Related U.S. Application Data
(60) Provisional application No. 60/764,112, filed on Feb. 1, 2006.

(51) Int. Cl. G06F 15/173

(52) U.S. Cl. 715/738; 709/224

(57) ABSTRACT

Organizing collected information about the configuration of a network to present in a graphical form relevant to management of the network. The presenting is with a presentation module configured to set spatial and dynamic attributes of a display of entities of the network based on the organized, collected information and to provide visualization in the display in accordance with the spatial and dynamic attributes.

### CROSS REFERENCE TO RELATED APPLICATIONS

This application claims priority to U.S. Provisional Patent Application Ser. No. 60/764,112 entitled “APPARATUS FOR DISPLAYING LARGE, COMPLEX OUT-OF-BAND AND IN-BAND NETWORK MANAGEMENT AND ACCESS ENTITIES” filed on Feb. 1, 2006, which is incorporated herein by reference.

### FIELD OF THE INVENTION

This invention relates to a system and method for multi-dimensional visualization of data and the operations that can be perceivably performed on that data.

### BACKGROUND OF THE INVENTION

Conventional network management and service management applications use a standard front-end interface to provide database visualization. However, the user experience is seemingly restrictive. The network graphs are not intuitive and mostly represent the network in a static two-dimensional image. This is neither effective nor appealing, because the current network infrastructure is highly diverse and distributed across many geographical locations. Traversal of entities and other scaling features are likely not available in these tools, which prevent them from providing visual recognition of the network entities in an enterprise level management system.

Network management and service management architectures may include a visualization component, but existing solutions fall short in providing necessary information transfer when the system is either complex or huge. They do not provide multi-dimensional visualization capabilities for cognitive recognition and lack scalability.

Supplementing the network graphical user interface that adequately provides the mapping between the cognitive response and visual stimuli will improve the user response tremendously. By amplifying the perceptual and cognitive process, users will experience faster search time and cognitive interaction between the appliances. The present approach addresses the above concerns by implementing multi-dimensional visualization enabled with dynamics across a complex network management infrastructure as an integral part of a user interface component.

### BRIEF SUMMARY OF THE INVENTION

A visual navigating interface and method for visualizing networked entities which includes a database mediator for retrieving data relative to the entities from at least one source, a presentation layer for creating visualized data with respect to spatial and dynamic attributes, and a graphical user interface (GUI) control component to present visualized data and manage user input. The spatial attributes include at least color, shape, spatial distance, temporal distance and combinations thereof and the dynamic attributes include at least one of a positional behavior based on quantity of displayed data, access pathways, user access restrictions, incident relations and combinations thereof.

### BRIEF DESCRIPTION OF THE DRAWINGS

FIG. 1 shows an exemplary block diagram of a data visualization framework used to provide a conceptual separation between the underlying data and the operations that can be performed upon them;

FIG. 2 is an exemplary flow chart of the network management visualization process in accordance with the invention.

FIG. 3 is an exemplary schematic tree representing visualization key elements and uses of a command center database pertaining to a visualization component in a graphical user interface;

FIG. 4 is an exemplary schematic representation of an initial command center client view in accordance with the invention;

FIG. 5 is an exemplary schematic representation of user groups and policy view for visualization of complex relationships between related network entities in an information technology service management architecture of the invention;

FIG. 6 is an exemplary user centric view of a command center database visualization component;

FIG. 7 is an exemplary schematic representation of a topological view user-to- port in accordance with the invention;

FIG. 8 depicts exemplary progressive views showing movement of entities when a cursor focus changes.

### DETAILED DESCRIPTION OF THE INVENTION

### I. Overview

In general, an exemplary embodiment of the system operates in an environment of one or more networks interconnecting a plurality of servers and other appliances. The system collects information about the configuration of the network, organizes it along multiple dimensions relevant to the management of the network and presents the information in a graphical form in response to input from an administrator of the network(s) or the appliances that allows the administrator to quickly and intuitively conceptualize the structures of the networks and appliances. Instead of mere symbol representation, the system provides feature sets that will elevate the vision and spatial thinking of the information being conveyed which is essential to Information Technology (IT) service management. The interface thus enhances the user perception and interaction with the associated network management and access appliance.

The need for such integrated visualization front-end is suited for network monitoring and management. In a typical scenario, the administrator would need to picture how their networks are configured in order to identify the problems and launch an associated access path to the target for resolution with minimal possible delay. The remote access and management leads to an unrecoverable damaged state if network connectivity and link integrity is incomprehensible or is resolved incorrectly.

The innovative system provides a novel component specific to network domains that act as a visual navigating front-end interface (“interface”) to out-of-band (i.e., network management access capability to a target even if operating system is not running) and in-band network access and management appliances. The multi-dimensional interface, in addition to providing shape and color visualization parameters, also provides controlled motion, which can be configured by the user to reflect the properties of the entities being displayed more effectively. As discussed in more detail below, a set of users who belong to certain groups (Administrators, Database Analysts, etc.) can be shown as a single cluster in the interface display in a logically appropriate manner. The details of the users along with their device access policies will be displayed whenever a user clicks on that spatial cluster shown in the interface display. The details may comprise of the user level permissions and their access path to the target servers using the out-of-band or in-band network appliances.

### II. Architecture and Operation

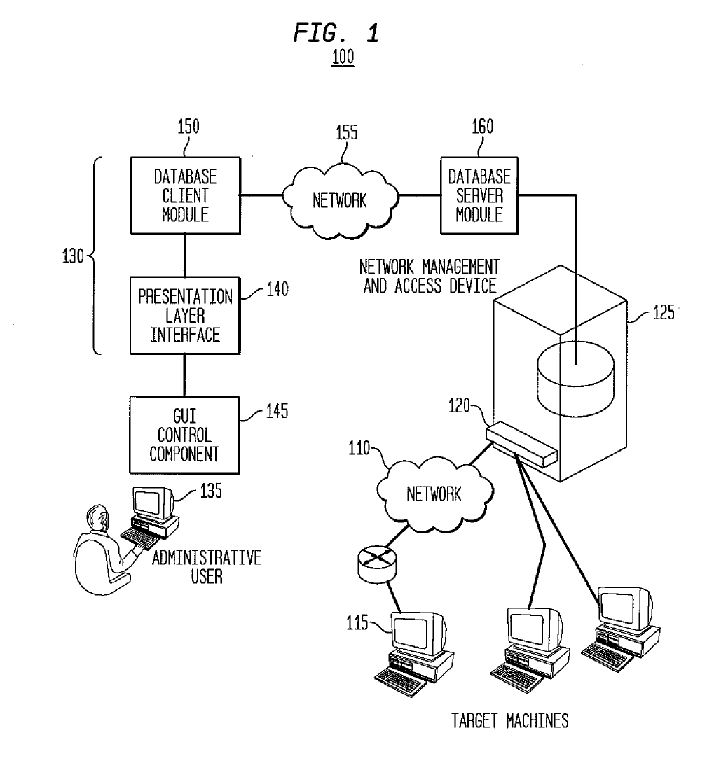

FIG. 1 depicts two aspects of the innovative system. FIG. 1 illustrates the physical components that are visualized using the system discussed herein. It also illustrates the design model and operational framework for how the system works. Specifically, a data visualization component is depicted that provides the conceptual separation between the underlying data and the operations that can be perceivably performed upon them. This design model provides a user interface with the following key features: a) intuitive, b) real-time interaction, and c) infinite dimensions of visual entities.

Referring now to FIG. 1, a system 100 operates in an environment of one or more networks 110 interconnecting a plurality of target servers/access entities 115, and appliances 120 together with a network management system 125. System 100 includes a visual navigating front-end interface 130 which takes the network data gathered by network management system 125 and visually organizes the data so that a user 135 can intuitively and quickly understand the network interconnectivity amongst user 135, targets 115, appliances 120 and network management system 125 via visual navigating front-end interface 130. The attributes of the visualization component are classified into the above three major categories, specifically pertaining to (a) users 135, (b) appliances 120 and (c) target servers or access entities 115. These are the three key components to the network management infrastructure.

Visual navigating front-end interface 130 is either downloadable or pushed from network management system 125. Interface 130 is comprised of a presentation layer interface 140, which is further connected to a graphical user interface (“GUI”) control component 145 that acts as the visualization component to present and manage the front-end accessed by user 135. Interface 130 also includes a database client module 150 that is coupled to presentation layer interface 140 and is further coupled to a database server module 160, which in turn is coupled to a network management system 125 over a secure socket layer over network 155. Database client module 150 and database server module 160 act together as a mediator between interface 130 and network management system 125. Since an aspect of the system focuses on the underlying mechanism to present the target server's or access entity's related details effectively to the user from the perspective of Information Technology (IT) service management, database client module 150 together with database server module 160 query the network management system 125 for the user's requirement and retrieves the relevant data to presentation layer interface 140 and GUI control component 145.

Presentation layer interface 140 consists of two modules. The first module is a layout manager component that arranges the data elements retrieved from network management system 125 in a suitable format. This in effect configures the spatial attributes of the display. Suitable formats include the use of color, shapes, closest in physical distance from user, closest in time, fastest pathway and other parameters to provide an intuitive visual display.

A second part of presentation layer interface 140 is a component responsible for dynamic attributes of the displayed entities including their properties. This includes but is not limited to their positional behavior based on the amount of data being displayed, the access paths between visualized entities and incident relations as described below. The term displayed entities generally refers to targets, appliances, and users.

As stated above, presentation layer interface 140 is coupled to and provides data to GUI control component 145. GUI control layer 145 has two functional components. The first functional component renders the visualization to the user's display and the second functional component receives inputs from the user. Specifically, it provides the user the ability to add and delete appliances, targets or device ports, users and user-groups, request different visualizations and status updates and any other user-generated input.

From another perspective, FIG. 1 also shows an operational framework that has four major components illustrating the basic design model. The first component is network management and access device 125. Network management and access device 125 has all the necessary control and management information pertaining to the network being managed. The second component of the framework is database server module 160, which acquires the connection to network management and access device 125 and delivers the query to it. Database server module 160 acts as an intermediary between a third component, database client module 150 and network management and access device 125. Database server module 160 sends the response from network management and access device 125 to a fourth component, graphical user interface (“GUI”) control component 145 through database client module 150. Database client module 150 caches this information before the information is processed by presentation layer interface 140. GUI control component 145 consists of the necessary controls to interact effectively with the data network that is currently being managed. In summary, this framework provides the end-to-end infrastructure necessary to visualize, manage and control the network through the out-of-band and in-band management and access appliances.

The basic functionality of the technology in this embodiment is implemented in the network management system or command center. The data presented at the front-end interface is derived from the database created and maintained at the command center. This client side framework enables the user to configure the command center and the underlying network. In the framework of the invention, this front-end module gets downloaded, as discussed above, from the command center and exports the state of the configured appliances to the user.

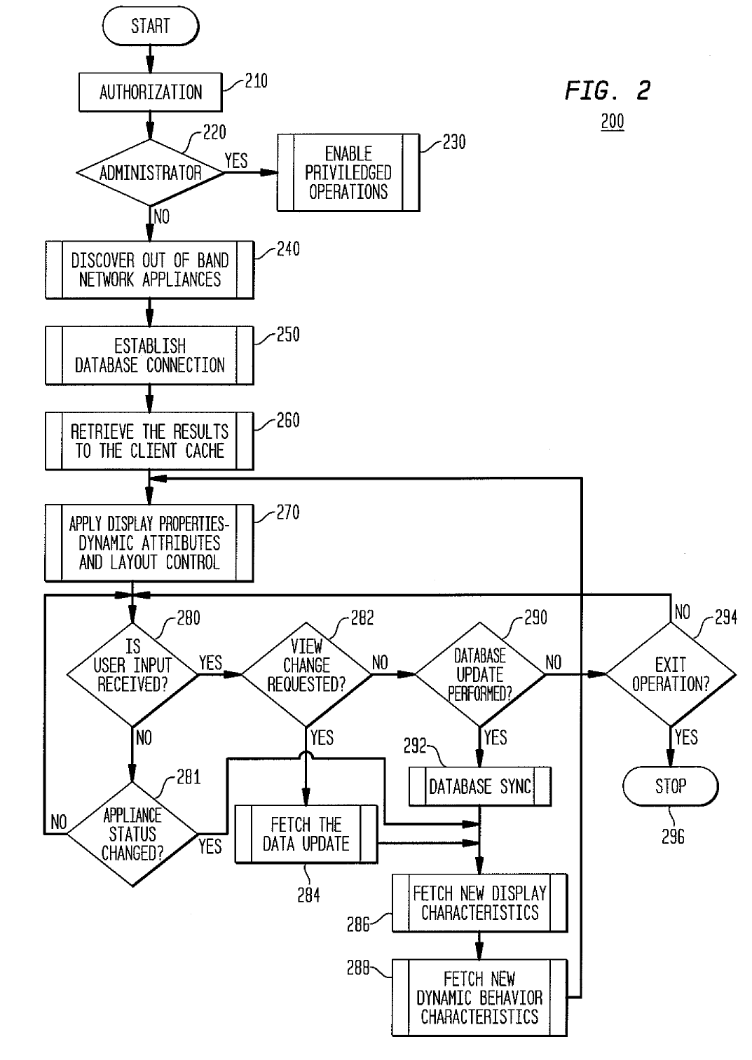

Referring now to FIG. 2, there is shown an exemplary flow chart 200 for implementing a visualization component. An authorization step 210 is performed once a user attempts to login to the system. If the user is an authorized administrator in step 220, then certain privileged operations are enabled in step 230. The user can send management commands to configure and access the appliances discovered by a network management system in steps 240-260. The system determines the appliances in step 240, established a connection with the databases in the appliances in step 250 and then obtains the appliance information such as but not limited to topology information, and user authorization information. The discovery of available appliances for access is achieved by parsing the response of the discovery packet sent by the appliances. The results are stored in the database client module in step 260. In addition to the appliances discovered by this process, the user and target information are created either by the user (limited privileges) or the administrator (full privileges).

Display or visualization properties, such as the dynamic attributes of the entities and the layout control, are applied to the gathered and inputted information in step 270.

In step 280, the system determines if the user has requested any changes. If no request has been made, then the system determines if any appliances have had status changes in step 281. If no user requests have been made and no status changes are present, the visualization remains the same.

If in step 280, a user has made a request, then the system determines if the request is a visualization change request or a status update request in step 282. If it is a visualization change request, then a request is made to fetch the user requested data from the network management system in step 284. The new display characteristics and new dynamic behavior characteristics are then fetched in steps 286 and 288, respectively. This new data is then processed as before in step 270.

If in step 282, it is a status update request, then the system determines if a network management system database has been performed in step 290. If no update has been done, then a network management system database synchronization is performed in step 292. This is accomplished by obtaining the new display characteristics and new dynamic behavior characteristics in steps 286 and 288, respectively. Again, this new data is then processed as before in step 270.

If in step 290, an update has already been performed, then the system determines if the user wishes to exit the interface in step 294. If not, the system recycles back to determine if further user requests have been input in step 280. Otherwise, the system exits at step 296.

Ill. Visualization Entities and Parameters

As stated above, the architecture and system shown in FIG. 1 is meant to visually and intuitively depict the pathways amongst users, target entities, access appliances or device and a network management system or command center.

In this sense, users refer to Information Technology administrators, Database analysts and Management Information System members and others who need to access the target servers in order to manage the services of a particular enterprise. Depending upon the responsibilities of the users, the permissions for accessing certain appliances and targets is allowed or restricted. In a real life scenario, the relationships between the users, appliances and the target servers are complex and evolving everyday. An intuitive framework for visualizing such complex inter-relationships is produced that embeds that visualization component as a part of the front-end interface.

Accordingly, the visualization component reflects those attributes in terms of the spatial and dynamic characteristics of the entities that are used to represent the users and their details. In a typical Information Technology infrastructure, users are normally grouped based on their responsibilities and skill. A similar approach is applied to groups as well. The attributes are derived in such a way that the visualization component user will be able to derive intuitive understanding of the structure of the user groups and their relationships to the appliances and the targets. In essence, the visualization component provides necessary information to derive the access path of a certain user and his/her permissions to a target server. With that information, the Administrator can easily add or remove the user to certain target server or appliance even under a multi-tiered topology. In a large network, this feature is valuable as it avoids incorrect configuration of appliances, targets and users. Spatial and functional characteristics also include but are not limited to distance, fastest pathway between entities, and server status.

The attributes of entities representing the appliances are derived from their values in incident resolution. An incident in information technology perspective denotes an unexpected behavior of system service. The appliances monitor the network for any such events and the monitoring is reflected to the user through the GUI. Typical information includes the status of the target server, the details of users accessing them at that time and the duration of the individual user session. The visualization component provides a way to immediately congregate the status of all the network entities and help resolve the incident with minimal delays. This is because the visualization component can traverse through all the network entities in multiple levels and dimensions which is beneficial to the incident resolution.

### IV. Exemplary Use Diagrams

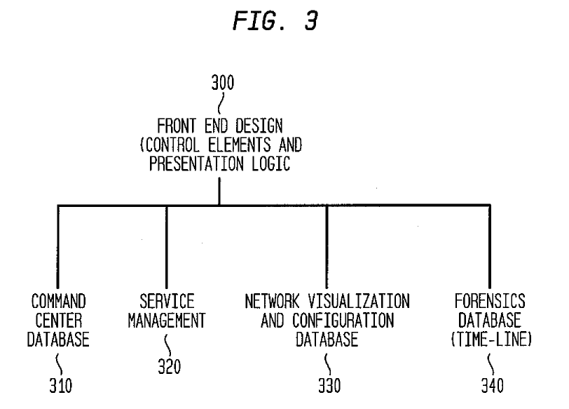

Referring now to FIG. 3, there are shown some exemplary potential uses of a navigable front-end interface 300 such as visualization of a network management system or command center database 310, service management 320, network topology and configuration 330 and forensics database 340. For example, in a service management framework, the target servers are accessed by an individual or a group of users. The user's sessions are recorded for monitoring purposes based on the configuration of the environment. The visualization component has chronological indexing to retrieve a session intuitively. In this way, all the sessions at the instant of incident can quickly be retrieved for analysis. In particular, the chronological view feature of interface 300 is operable for forensics server management.

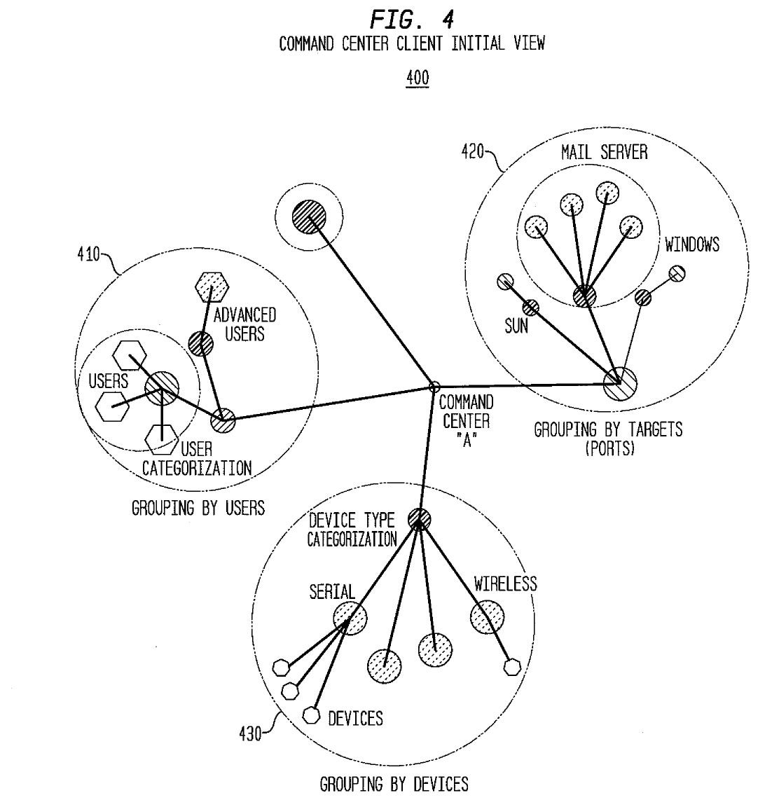

Referring now to FIGS. 4-7, there is shown an exemplary scenario of using this technology for visualizing complex relationships between related network entities. As seen in the FIGS. 4-7, the interface provides the platform for the visualization of network related entities, such as for connectivity and controlled access.

Referring now to FIG. 4, there is shown a command center client initial view 400. When a user logs into the command center and configures the appliance for the first time, he/she is then able to request the graphic front-end interface through their web browser and would obtain a view similar to that shown in FIG. 4. FIG. 4 illustrates grouping by users 410, grouping by ports or targets 420 and grouping by appliances 430.

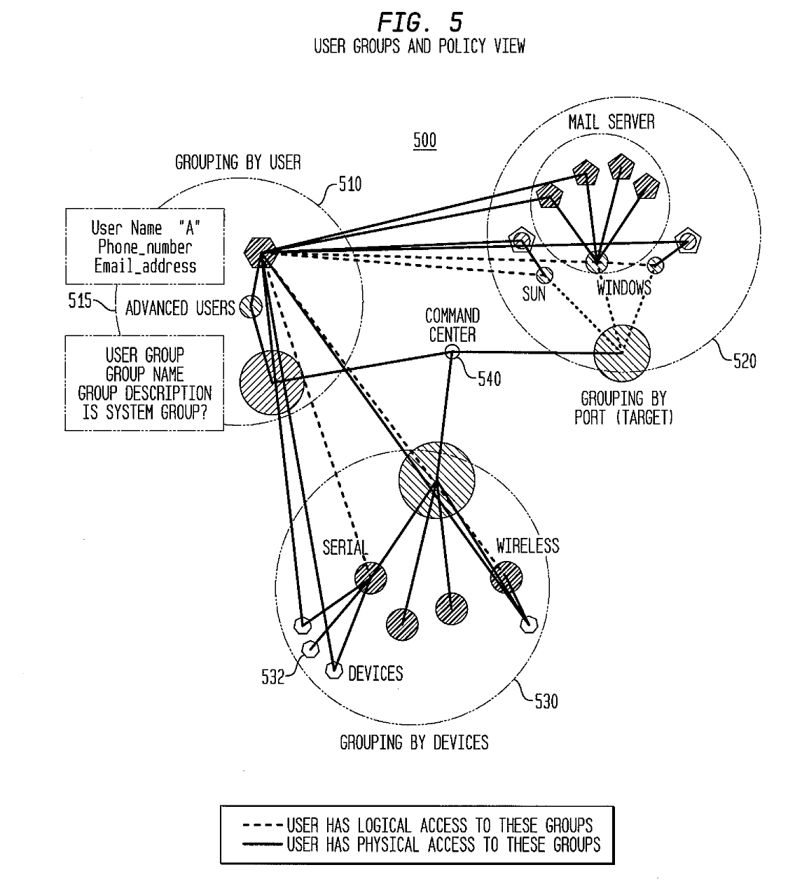

Referring now to FIG. 5, there is shown a display that depicts user groups and policy view 500. View 500 illustrates grouping by users 510, grouping by ports or targets 520 and grouping by appliances 530. Dotted lines extending between the groups represent the user having logical access to these groups. Solid lines extending between the groups represent the user having physical access to these groups. Some data underlying the groups may include user name, phone number, email address and, in the case of advanced users 515, the data may also include user group, group name, and group description in the system. A command center 540 may be represented at the center between the groups acting as a secure gateway between users in group 510 and the appliances in group 520 on the access paths to the target servers in group 530. The grouping by appliances may include grouping by devices, serial connectivity and wireless connectivity. The grouping by port or targets may be based on the services resident on the particular target, such as a mail application or a database application or based on platforms, for example, operating systems.

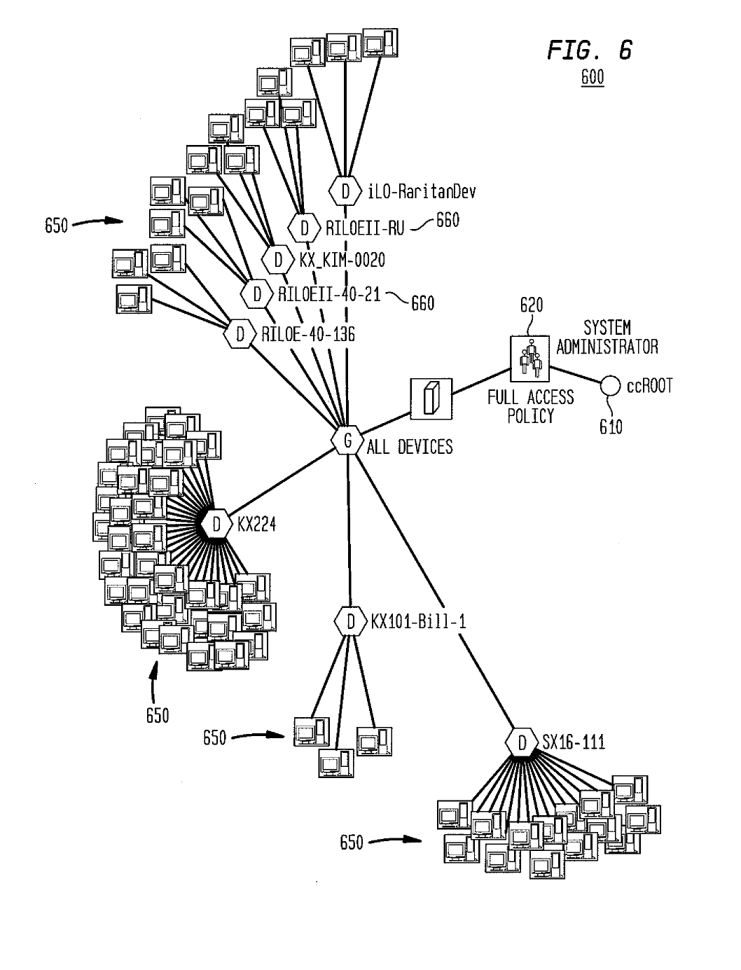

Referring now to FIG. 6, there is shown a user centric view 600 of a sample command center database visualization. In view 600, a network management system or command center is shown as 610. A user 620 having full access policy (as discussed above with respect to flowchart 200) can view all targets 650 that are connected via appliances 660. This view shows all pathways that exist for accessing through out of band between the different visualized entities in the exemplary network system. The viewer frame shows the association of user 620, appliances or access devices 660 and targets or ports 650 to a command center 610.

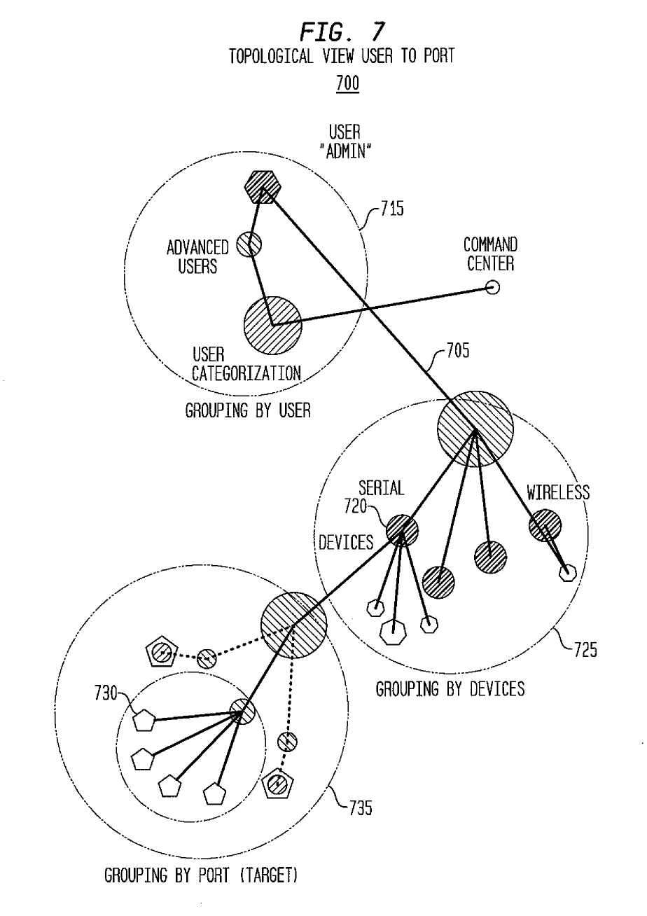

Referring now to FIG. 7, there is shown a topological view 700 depicting the relationship between a specific user-to-port. In particular, there is a pathway 705 which visualizes the connection between a user 710 in user group 715 to a device 720 in device group 725 and finally to a target 730 in a target group 735.

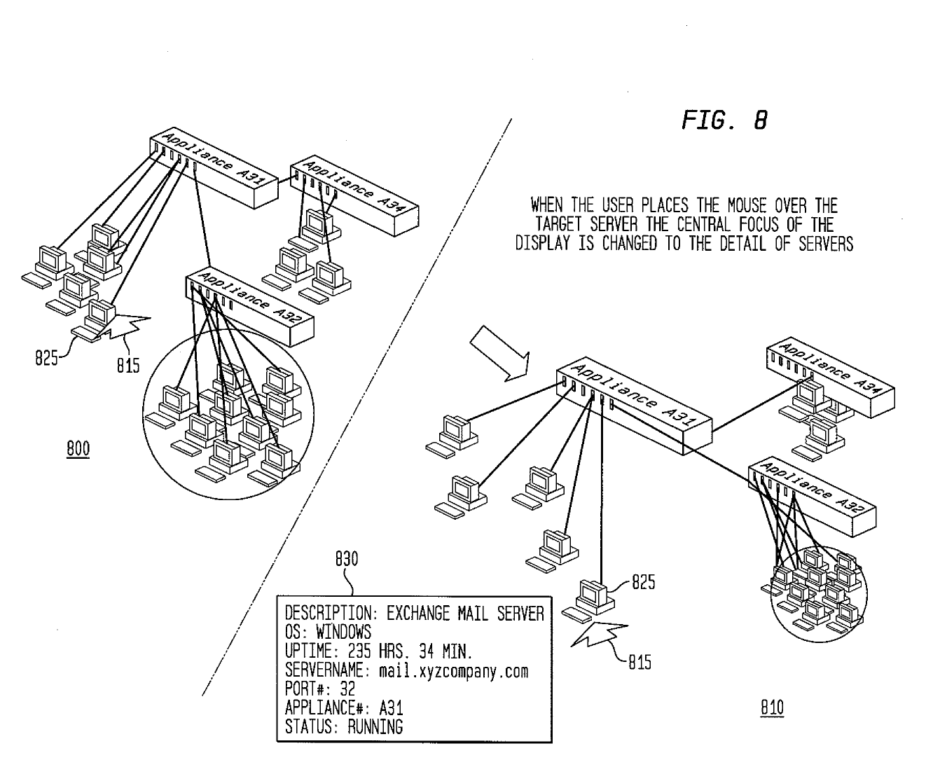

Referring now to FIG. 8, the innovative concept of controlled motion is illustrated. Controlled motion is the intelligent representation of specific items of interest to a user. Illustrated is how the movement of entities is reconfigured to adjust themselves when the cursor focus changes. In view 800, an appliance centric view is displayed. When a cursor 815 is brought on to a specific target server 825, a new view 810 is rendered where the focus has been re-adjusted on appliance A31, which among other target servers has target server 825 as a connected entity. By re-focusing and re-positioning the visualized entities around appliance A31, higher level details and characteristics of target server 825 can be emphasized. In particular, higher level details are displayed in a window 830 tied to target server 825. As can be seen, appliance A32 and A34 are shifted to de-emphasize and minimize their appearance and maximize target server entities managed by appliance A31 in view 810.

What is presented above is an apparatus to display network management and access entities using a presentation module configured to set spatial attributes of a display of entities, which are associated with retrieved data elements, and to set dynamic attributes of the display of entities including their positioned behavior relative to each other based on an amount of data being displayed, and finally to provide visualization in the display in accordance with the set spatial attributes and set dynamic attributes. The presentation module is configured to add or delete appliances, device ports, user and user-groups to or from the display of entities. It also is configured to configure the entities in the display to adjust themselves as a cursor focus changes to reveal higher details of the adjusted entities, where the higher details include information indicative of status, user access, and duration of a user session.

Also presented is a system and method for visualizing entities interconnected through networks. The system comprises a first component for collecting data about the entities, a second component which receives the data from the first component and organizes the data using at least spatial and dynamic attributes; and a third component for rendering visualized data and receiving user input. The spatial attributes include at least color, shape, spatial distance, temporal distance and combinations thereof and the dynamic attributes include at least one of a positional behavior based on quantity of displayed data, access pathways, user access restrictions, incident relations and combinations thereof. The system can determine an access pathway amongst specific entities in response to an event which can generated by an incident in the network or amongst the entities or by a user. The entities can include users, targets, appliances and a network management system and are grouped in accordance with specified parameters. The system adds or deletes appliances, device ports, user and user-groups to or from the display of entities; generates different visualizations; and performs status updates. The system can automatically adjust the data in the display as a cursor focus changes to reveal higher details of the data representing the entities, where the higher details include information indicative of status, user access, and duration of a user session. The data is collected from entities databases, network management system, forensics database, user inputs and combinations thereof.

Also presented is a visual navigating interface for visualizing networked entities which comprises a database mediator for retrieving data relative to the entities from at least one source, a presentation layer for creating visualized data with respect to spatial and dynamic attributes, and a graphical user interface (GUI) control component to present visualized data and manage user input. The mediator has a client side database and a server side database.

Also presented is method for visualizing entities interconnected through networks. The steps comprise retrieving data relative to the entities from at least one source, generating visualized data with respect to spatial and dynamic attributes; and rendering the visualized data. The data can be obtained the data from entities databases, network management system, forensics database, user inputs and combinations thereof. The method also determines access pathways amongst specific entities in response to an event, wherein the event is generated by an incident in the network or amongst the entities or is a user generated event. The method allows for adding entities, deleting entities, generating different visualizations, and updating visualization status. The method also automatically adjusts the data in the display as a cursor focus changes to reveal higher details of the data representing the entities.

Although an exemplary network environment is described above, any network or interconnection of computers, servers, appliances and other devices are applicable and can be used with respect to the system and method described above. The teachings of the present invention can be applied to any data communication network including for example the Internet. Computers commonly operate in a networked environment using logical connections to one or more computers. The computer may be another personal computer, a server, a router, a network PC, a peer device or other common network node, and typically includes many or all of the elements described above. The logical connections include local area network (LAN), wide area network (WAN) and other such networking environments that are commonplace in offices, enterprise-wide computer networks, intranets, and the Internet. It will be appreciated that the network connections shown are exemplary and other means of establishing a communications link between the computers may be used. For purposes of illustration, programs and other executable program components such as the operating system are illustrated herein as discrete blocks, although it is recognized that such programs and components reside at various times in different storage components of the computer, and are executed by the data processor(s) of the computer. Different combinations of hardware and software can be used to carry out the teachings of the present invention.

While the foregoing description and drawings represent the preferred embodiments of the present invention, it will be understood that various changes and modifications may be made without departing from the spirit and scope of the present invention.

What is claimed is:

1. An apparatus to display network management and access entities, comprising,
a presentation module configured to set spatial attributes of a display of entities, which are associated with retrieved data elements, to set dynamic attributes of the display of entities including their positioned behavior relative to each other based on an amount of data being displayed, and to provide visualization in the display in accordance with the set spatial attributes and set dynamic attributes.

2. An apparatus of claim 1, wherein the presentation module is configured to add or delete appliances, device ports, user and user-groups to or from the display of entities.

3. An apparatus of claim 1, wherein the presentation module is configured to configure the entities in the display to adjust themselves as a cursor focus changes to reveal higher details of the adjusted entities.

4. An apparatus of claim 1, wherein the higher details include information indicative of status, user access, and duration of a user session.

5. A system for visualizing entities interconnected through networks, comprising:
a first component for collecting data about the entities;
a second component which receives the data from the first component and organizes the data using at least spatial and dynamic attributes; and
a third component for rendering visualized data and receiving user input

6. The system of claim 5, wherein spatial attributes include at least color, shape, spatial distance, temporal distance and combinations thereof.

7. The system of claim 6, wherein dynamic attributes include at least one of a positional behavior based on quantity of displayed data, access pathways, user access restrictions, incident relations and combinations thereof.

8. The system of claim 5, wherein the second component determines an access pathway amongst specific entities in response to an event.

9. The system of claim 8, wherein the event is generated by an incident in the network or amongst the entities.

10. The system of claim 7, wherein the entities include at least users, targets, appliances and a network management system.

11. The system of claim 10, wherein users, targets and appliances are grouped in accordance with specified parameters.

12. The system of claim 5, wherein the second component handles at least one of adds or deletes appliances, device ports, user and user-groups to or from the display of entities; requests for different visualizations; and status updates.

13. The system of claim 5, wherein the second component automatically adjusts the data in the display as a cursor focus changes to reveal higher details of the data representing the entities.

14. The system of claim 13, wherein the higher details include information indicative of status, user access, and duration of a user session.

15. The system of claim 10, wherein data is collected from at least one of a entities databases, network management system, forensics database, user inputs and combinations thereof.

16. A visual navigating interface for visualizing networked entities, comprising:
a database mediator for retrieving data relative to the entities from at least one source;
a presentation layer for creating visualized data with respect to spatial and dynamic attributes; and
a graphical user interface (GUI) control component to present visualized data and manage user input.

17. The interface of claim 16, wherein the mediator has a client side database and a server side database.

18. The interface of claim 16, wherein
the spatial attributes include at least color, shape, spatial distance, temporal distance and combinations thereof; and
the dynamic attributes include at least one of a positional behavior based on quantity of displayed data, access pathways, user access restrictions, incident relations and combinations thereof.

19. The interface of claim 16, wherein the presentation layer determines an access pathway amongst specific entities in response to an event, wherein the event is generated by an incident in the network or amongst the entities or is a user generated event.

20. The interface of claim 18, wherein the entities include at least users, targets, appliances and a network management system and are grouped in accordance with specified parameters.

21. The interface of claim 20, wherein the presentation layer handles user requests from the GUI control component to add entities, delete entities, generate different visualizations, and update visualization status.

22. The interface of claim 18, wherein the presentation layer automatically adjusts the data in the display as a cursor focus changes to reveal higher details of the data representing the entities.

23. The interface of claim 18, wherein data is collected from at least one of a entities databases, network management system, forensics database, user inputs and combinations thereof.

24. A method for visualizing entities interconnected through networks, comprising:
retrieving data relative to the entities from at least one source;
generating visualized data with respect to spatial and dynamic attributes; and
rendering the visualized data.

25. The method of claim 24, wherein the step of receiving obtains the data from at least one of a entities databases, network management system, forensics database, user inputs and combinations thereof.

26. The method of claim 24, wherein
the spatial attributes include at least color, shape, spatial distance, temporal distance and combinations thereof; and
the dynamic attributes include at least one of a positional behavior based on quantity of displayed data, access pathways, user access restrictions, incident relations and combinations thereof.

27. The method of claim 26, wherein the step of generating includes the step of determining an access pathway amongst specific entities in response to an event, wherein the event is generated by an incident in the network or amongst the entities or is a user generated event.

27. The method of claim 26, wherein the entities include at least users, targets, appliances and a network management system and are grouped in accordance with specified parameters.

28. The method of claim 27 of claim 20, wherein the step of generating includes at least one step of adding entities, deleting entities, generating different visualizations, and updating visualization status.

29. The method of claim 26, further including the step of automatically adjusting the data in the display as a cursor focus changes to reveal higher details of the data representing the entities.
